(19) United States
(12) Patent Application Publication
(10) Pub. No.: US 2006/0181158 A1
(43) Pub. Date: Aug. 17, 2006

(54) Cylindrical linear motor, electromagnetic suspension, and vehicle using the same

(75) Inventors: Fumio Tajima, Hitachi (JP); Masashi Kitamura, Mito (JP); Houngjoong Kim, Hitachi (JP); Yusuke Akami, Yokohama (JP); Noriyuki Utsumi, Tokyo (JP); Ken Nakamura, Yokohama (JP); Kazuaki Shibahara, Yokohama (JP)

Correspondence Address: CROWELL & MORING LLP;INTELLECTUAL PROPERTY GROUP, P.O. BOX 14300, WASHINGTON, DC, 20044-4300, US

(73) Assignee: HITACHI, LTD., Tokyo (JP)

(21) Appl. No.: 11/317,027

(22) Filed: Dec. 27, 2005

(30) Foreign Application Priority Data
Dec. 27, 2004 (JP) 2004-376187

(51) Int. Cl. H02K 41/00

(52) U.S. Cl. 310/12

(57) ABSTRACT

A cylindrical linear motor, an electromagnetic suspension, and a vehicle using the same, which can generate a large thrust and reduce torque pulsations and cogging torque. The cylindrical linear motor comprises a stator and a slider disposed with a gap left relative to the stator and being linearly movable relative to the stator. The stator comprises a stator core having stator salient poles, and 3-phase stator windings inserted in slots formed in the stator core. The slider comprises a plurality of permanent magnets fixed to a slider core. The motor satisfies τp:τs=9:9±1 where τs is a pitch of the stator salient poles and τp is a pitch of the permanent magnets.

### BACKGROUND OF THE INVENTION

1. Field of the Invention

The present invention relates to a cylindrical linear motor, an electromagnetic suspension, and a vehicle using the same.

2. Description of the Related Art

In one known example of electromagnetic suspensions disclosed in JP-A-2004-53003 (Patent Document 1), a 3-phase synchronous cylindrical linear motor is used as a motor for an electromagnetic suspension. The 3-phase synchronous cylindrical linear motor has a structure that coils are mounted to the inner peripheral side of an outer cylinder (stator) of a double cylinder, and a magnet is mounted to the outer peripheral side of an inner cylinder (slider). A stator core is not used.

JP-A-7-276963 (Patent Document 2) discloses another known example in which a 3-phase asynchronous (inductive) cylindrical linear motor comprising a stator core formed of a ring-shaped spacer and a stator formed of coils is used as a motor for an electromagnetic suspension.

### SUMMARY OF THE INVENTION

However, the electromagnetic suspension disclosed in JP-A-2004-53003 has the problem as follows. Because it is of the gap winding type having the coils disposed in a space between the outer and inner cylinders without using the stator core on the stator side, the distance between the inner surface of a stator yoke on the outer cylinder side and the outer peripheral surface of the magnet mounted to the outer peripheral side of the inner cylinder is increased, thus resulting in a small thrust.

Also, the electromagnetic suspension disclosed in JP-A-7-276963 has the problem that, because of the structure having no magnet on the slider side, an electromotive force is small, thus resulting in a small thrust.

In view of those problems with the related art, the inventors have made studies on a magnet type 3-phase synchronous motor in which a stator core is mounted to a stator on the outer cylinder side and a magnet is mounted to a slider on the inner cylinder side, aiming at a larger thrust. Through the studies, it has been found that, when the inner cylinder slides relative to the outer cylinder, large pulsations are caused in the generated thrust with changes in position of the magnet mounted to the inner cylinder. Also, it has been found that cogging torque is increased. When the magnet type 3-phase synchronous motor is used in a vehicular electromagnetic suspension, the large torque pulsations and the increased cogging torque become factors deteriorating ride comfortableness.

An object of the present invention is to provide a cylindrical linear motor, an electromagnetic suspension, and a vehicle using the same, which can generate a large thrust and reduce torque pulsations and cogging torque.

The cylindrical linear motor, the electromagnetic suspension, and the vehicle using the same, which can generate a large thrust and reduce torque pulsations and cogging torque, are realized with the following features.

The most essential feature of the present invention resides in satisfying τp:τs=9:9±1 on an assumption that a pitch of stator salient poles is τs and a pitch of permanent magnets is τp.

Features in a preferable form of a cylindrical linear motor according to the present invention are as follows.

In a cylindrical linear motor comprising a stator and a slider disposed with a gap left relative to the stator and being linearly movable relative to the stator, the stator comprises a stator core having stator salient poles; and 3-phase stator windings inserted in slots formed in the stator core, the slider comprises a plurality of permanent magnets fixed to a slider core, and the motor satisfies τp:τs=9:9±1 where τs is a pitch of the stator salient poles and τp is a pitch of the permanent magnets.

Features in a preferable form of an electromagnetic suspension according to the present invention are as follows.

In an electromagnetic suspension comprising a cylindrical linear motor comprising a stator including stator windings, and a slider disposed with a gap left relative to the stator and being linearly movable relative to the stator; and a control unit for controlling currents supplied to the stator windings of the cylindrical linear motor, the stator comprises a stator core having stator salient poles; and 3-phase stator windings inserted in slots formed in the stator core, the slider comprises a plurality of permanent magnets fixed to a slider core, and the motor satisfies τp:τs=9:9±1 where τs is a pitch of the stator salient poles and τp is a pitch of the permanent magnets.

Features in a preferable form of a vehicle according to the present invention are as follows.

In a vehicle comprising an electromagnetic suspension unit mounted between a vehicle body and a wheel and including a cylindrical linear motor which comprises a stator including stator windings, and a slider disposed with a gap left relative to the stator and being linearly movable relative to the stator; a control unit for controlling currents supplied to the stator windings of the cylindrical linear motor in the electromagnetic suspension unit; and a plurality of normal acceleration sensors for detecting normal vibrations of the vehicle body, the stator of the cylindrical linear motor comprises a stator core having stator salient poles; and 3-phase stator windings inserted in slots formed in the stator core, the slider comprises a plurality of permanent magnets fixed to a slider core, the motor satisfies τp:τs=9:9±1 where τs is a pitch of the stator salient poles and τp is a pitch of the permanent magnets, and the control unit controls the currents supplied to the stator windings of the cylindrical linear motor in such a manner that the vibrations of the vehicle detected by the normal acceleration sensors are suppressed.

According to the present invention, it is possible to generate a large thrust and to reduce torque pulsations and cogging torque.

### BRIEF DESCRIPTION OF THE DRAWINGS

FIG. 1 is a longitudinal sectional view showing the structure of a cylindrical linear motor used in an electromagnetic suspension according to an embodiment of the present invention;

FIG. 2 is a sectional view taken along the line A-A in FIG. 1;

FIG. 3 is an enlarged view of a principal part in FIG. 1;

FIG. 4 is a plan view showing the arrangement of stator windings of the cylindrical linear motor used in the electromagnetic suspension according to the embodiment;

FIGS. 5A-5D are illustrations and graphs for explaining the effect resulting when the cylindrical linear motor used in the electromagnetic suspension according to the embodiment satisfies τp:τs=9:8;

FIGS. 6A-6D are illustrations and graphs for explaining the effect resulting when the cylindrical linear motor used in the electromagnetic suspension according to the embodiment is provided with auxiliary salient poles;

FIG. 7 is a longitudinal sectional view showing the structure of a cylindrical linear motor used in an electromagnetic suspension according to a modification of the embodiment;

FIG. 8 is a system block diagram showing the configuration of the electromagnetic suspension according to the embodiment;

FIG. 9 is a block diagram showing the configuration of a principal part of the electromagnetic suspension according to the embodiment; and

FIG. 10 is a block diagram showing the configuration of a driver circuit used in the electromagnetic suspension according to the embodiment.

### DESCRIPTION OF THE PREFERRED EMBODIMENTS

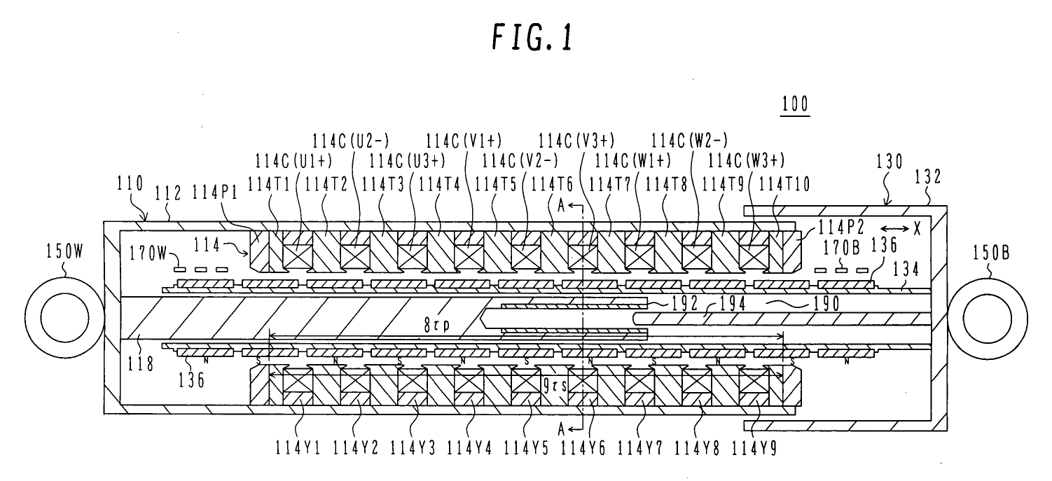

The structure of an electromagnetic suspension according to an embodiment of the present invention will be described below with reference to FIGS. 1-6.

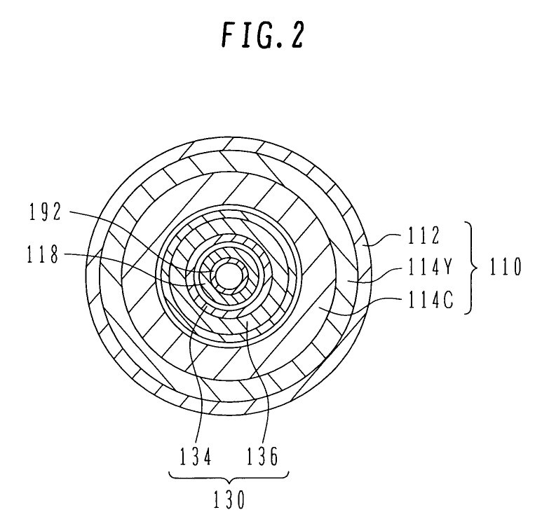

First, the structure of a cylindrical linear motor used in the electromagnetic suspension of the embodiment will be described with reference to FIGS. 1 and 2.

FIG. 1 is a longitudinal sectional view showing the structure of the cylindrical linear motor used in the electromagnetic suspension according to the embodiment. FIG. 2 is a sectional view taken along the line A-A in FIG. 1.

A permanent magnet type 3-phase cylindrical linear motor 100 of the embodiment comprises a cylindrical stator 110 and a cylindrical slider 130 held inside the stator 110 in a slidable manner.

The stator 110 comprises a stator case 112, a stator core 114, stator windings 114C, and a stator inner case 118. The stator case 112 has a cylindrical shape provided with the bottom, and a mounting portion 150W is fixed to an outer end surface of the bottom portion. Also, undulations (not shown) for promoting heat radiation are formed on an outer periphery of the stator case 112. The stator core 114 is fixed to the inner peripheral side of the stator case 112. The stator case 112 is made up of two parts prepared by splitting a cylindrical case provided with the bottom into halves along the axial direction. The halves form a cylindrical shape as a whole when they are mated with each other at their split surfaces. More specifically, the stator 110 is constructed by arranging various components (i.e., later-described stator core yokes 114Y, stator core teeth (stator salient poles) 114T, stator windings 114C, and auxiliary salient poles 114P) of the stator 110 in one split half of the stator case 112, and then placing the other half of the stator case 112 over the one half.

The stator core 114 is made up of nine ring-shaped stator core yokes 114Y (114Y1, 114Y2, . . . , 114Y9), ten ring-shaped stator core teeth (stator salient poles) 114T (114T1, 114T2, . . . , 114T10), and two ring-shaped auxiliary salient poles 114P (114P1, 114P2). The stator core yokes 114Y, the stator core teeth 114T, and the auxiliary salient poles 114P are each made of iron. The stator core teeth 114T are constituted separately from the stator core yokes 114Y. As compared with the case of forming the teeth and the yokes as an integral structure, therefore, those components can be each constructed in the simpler ring-like form and manufacturability is improved. Additionally, the stator core teeth 114T may be made of a green compact that is formed by solidifying iron powder under compression. The use of a green compact is effective in increasing the resistance value of the stator core teeth, reducing eddy current loss, and hence increasing torque generated.

The stator core teeth 114T are each arranged between adjacent two of the stator core yokes 114Y such that, for example, the stator core yoke 114Y1 is disposed between the stator core tooth 114T1 and the stator core tooth 114T2. The auxiliary salient pole 114P1 is disposed adjacent to one surface of the stator core tooth 114T1 on the side opposite to the other surface thereof held in contact with the stator core yoke 114Y1. Also, the auxiliary salient pole 114P2 is disposed adjacent to one surface of the stator core tooth 114T10 on the side opposite to the other surface thereof held in contact with the stator core yoke 114Y9. The auxiliary salient poles 114P1, 114P2 are disposed on both sides of the stator core and serve to smoothen changes of magnetic flux at both the ends of the stator core.

Nine stator windings 114C (114C(U1+), 114C(U2−), 114C(U3+), 114C(V1+), 114C(V2−), 114C(V3+), 114C(W1+), 114C(W2−), and 114C(W3+)) are disposed respectively in nine slots each of which is formed by one stator core yoke 114Y and two stator core teeth 114T positioned on both sides of the former. For example, the stator winding 114C1 is disposed in the slot formed by the stator core yoke 114Y1 and the stator core teeth 114T1, 114T2 positioned on both sides of the former. The stator windings 114C are each formed by winding an enamel-coated copper wire into a ring-like shape of plural turns. The stator windings 114C(U1+), 114C(U2−) and 114C(U3+) constitute a U-phase stator coil, the stator windings 114C(V1+), 114C(V2−) and 114C(V3+) constitute a V-phase stator coil, and the stator windings 114C(W1+), 114C(W2−) and 114C(W3+) constitute a W-phase stator coil. Looking at the U-phase stator coil, the stator winding 114C(U1+) and the stator winding 114C(U3+) are wound in the same direction such that currents flow through those stator windings in the same direction, while the stator winding 114C(U2−) is wound in a direction reversal to the direction of the stator winding 114C(U1+) such that a current flows through the stator winding 114C(2−) in the reversed direction.

Projections projecting in the direction indicated by X are formed at the innermost peripheral end of each of the stator core teeth 114T, whereby the width of an entrance opening of the slot is narrowed to be smaller than that of the stator winding 114C.

The slider 130 comprises a slider case 132, a slider core 134, and eleven permanent magnets 136. The slider case 132 has a cylindrical shape provided with the bottom, and its inner diameter is larger than the outer diameter of the stator case 112. Also, a mounting portion 150B is fixed to an outer end surface of the bottom of the slider case 132. The slider core 134 has a cylindrical shape and is fixed to the bottom of the slider case 132. The eleven permanent magnets 136 have a ring-like shape and are mounted to the outer peripheral side of the slider core 134 in spaced relation at equal intervals. Polarities of the permanent magnets 136 are arranged such that N poles and S poles of the adjacent permanent magnets are alternately arrayed in the axial direction. A predetermined gap is left between the outer peripheral surfaces of the permanent magnets 136 and the inner peripheral surfaces of the stator core teeth 114T, thus allowing the slider 130 to reciprocally slide inside the stator 110 in a non-contact way in the direction indicated by X.

Pole position sensors 170W, 170B each made up of three Hall devices are disposed respectively near the outer peripheries of two permanent magnets positioned at both ends of the slider 130. The three Hall devices detect pole positions of the U-, V- and W-phase, respectively. A stroke sensor stator 192 is disposed at an end of the stator inner case 118 on the side closer to the slider 130, and a rod-like stroke sensor slider 194 is fixed to the bottom of the slider case 132 of the slider 130. The stroke sensor stator 192 and the stroke sensor slider 194 cooperatively constitute a stoke sensor 190. The stroke sensor 190 is a linear sensor for detecting the amount of movement of the slider 130 relative to the stator 110 in the X-direction. For example, the stroke sensor 190 detects the amount of movement (stroke) of the slider 130 based on the principle of a potentiometer. As an alternative, the stoke sensor 190 may be a non-contact sensor utilizing reluctance. Additionally, the stoke sensor can also be used instead of the pole position sensor or used as an acceleration sensor.

In the embodiment, assuming that the center-to-center distance between the adjacent stator core teeth (stator salient poles) 114T (i.e., the pitch of the stator salient poles) is τs and the center-to-center distance between the adjacent permanent magnets 136 (i.e., the pitch of the permanent magnets) is τp, τp:τs=9:8 is satisfied. In other words, the relationship of 9τs=8τp holds.

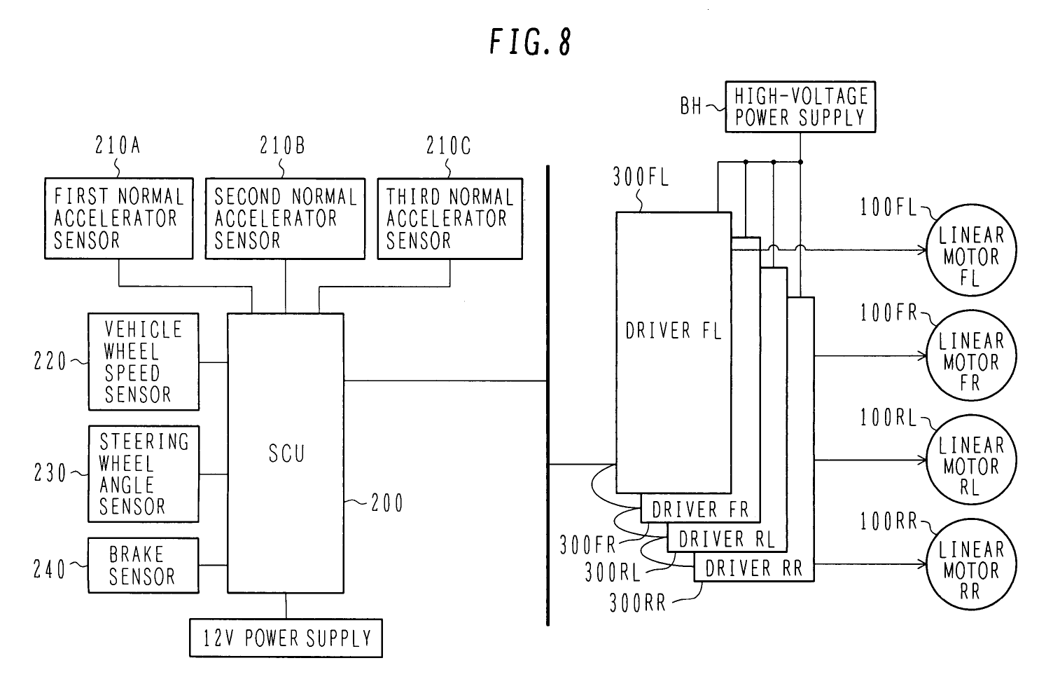

The electromagnetic suspension is constituted by combining the cylindrical linear motor, which is made up of the stator 110 and the slider 130 described above, with a control unit for controlling currents supplied to the stator windings 114C, to thereby control the thrust generated. The configuration of the control unit will be described later with reference to FIGS. 8-10. The electromagnetic suspension is used in motor vehicles, railway vehicles, etc. In such an application, the mounting portion 150B is mounted to the body side of the vehicle and the mounting portion 150W is mounted to the wheel side of the vehicle.

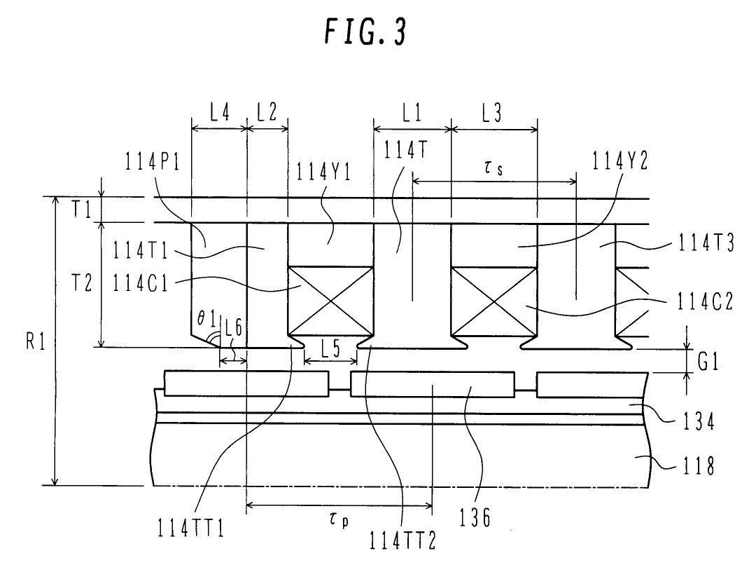

Detailed dimensions of the various components will be described below with reference to FIG. 3.

FIG. 3 is an enlarged view of a principal part in FIG. 1. Note that the same reference numerals as those in FIG. 1 denote the same components.

The dimensions of the various components described below represent values when the embodiment is applied to the electromagnetic suspension for use in motor vehicles. Assuming that the outer diameter of the stator 110 is R1, the thickness of the stator case 112 is T1, the thickness of each stator core tooth (stator salient pole) 114T in the radial direction is T2, and the length of the stator core tooth 114T2 in the axial direction (X-direction in FIG. 1) is L1, the width (axial length) of the stator core teeth 114T3, . . . , 114T9 is also L1. The axial length T2 of the stator core tooth 114T1 is half that of the stator core tooth 114T2.

Assuming the axial length of the stator core yoke 114Y2 to be L3, the axial length of the other stator core yokes 114Y1, . . . , 114Y9 is also the same L3. Assuming the axial length of the auxiliary salient pole 114P1 to be L4, the axial length of the auxiliary salient pole 114P2 is also the same L4. Each of the auxiliary salient poles 114P1, 114P2 has a ring-like shape having, as shown, a partly sloped inner peripheral surface and a cylindrical portion on the side held in contact with the stator core tooth 114T1 or 114T10. The axial length of the cylindrical portion is L6, and an angle θ1 of the partly sloped inner peripheral surface of the auxiliary salient pole 114P1 relative to the axial direction is 20°. Assuming the spacing between adjacent projections 114TT1, 114TT2 at the innermost peripheral ends of the two stator core teeth 114T is L5, the spacing between the other adjacent projections is also the same L5.

The center-to-center distance τs between the adjacent stator core teeth (stator salient poles) 114T (i.e., the pitch of the stator salient poles) is 10 mm. On the other hand, the center-to-center distance τp between the adjacent permanent magnets 136 (i.e., the pitch of the permanent magnets) is 11.25 mm. Accordingly, the relationship of τp:τs=9:8, i.e., 9τs=8τp, holds.

The distance G between the inner peripheral surface of each stator core tooth 114T and the outer peripheral surface of each permanent magnet 136 of the slider 130 is 0.5 mm.

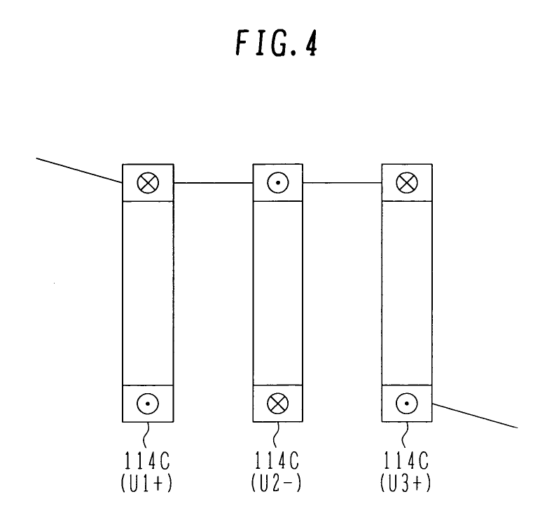

A method of winding the stator windings of the cylindrical linear motor used in the electromagnetic suspension according to the embodiment will be described below with reference to FIG. 4.

FIG. 4 is a plan view showing the arrangement of the stator windings of the cylindrical linear motor used in the electromagnetic suspension according to the embodiment. Note that the following description is made of the U-phase stator windings, but it is similarly applied to the other V- and W-phase stator windings.

The U-phase stator windings are made up of the stator windings 114C(U1+), 114C(U2−) and 114C(U3+). The stator winding 114C(U1+) and the stator winding 114C(U3+) are wound in the same direction such that currents flow through those stator windings in the same direction, while the stator winding 114C(U2−) is wound in a direction reversal to the direction of the stator winding 114C(U1+) such that a current flows through the stator winding 114C(2−) in the reversed direction. Here, the three stator windings 114C(U1+), 114C(U2−) and 114C(U3+) are continuously wound. By constituting the coil of the same phase with the continuous winding, work for interconnecting the coils is reduced and hence manufacturability is improved. Further, the 3-phase windings of the U-, V- and W-phases are connected to each other in the star (Y) form.

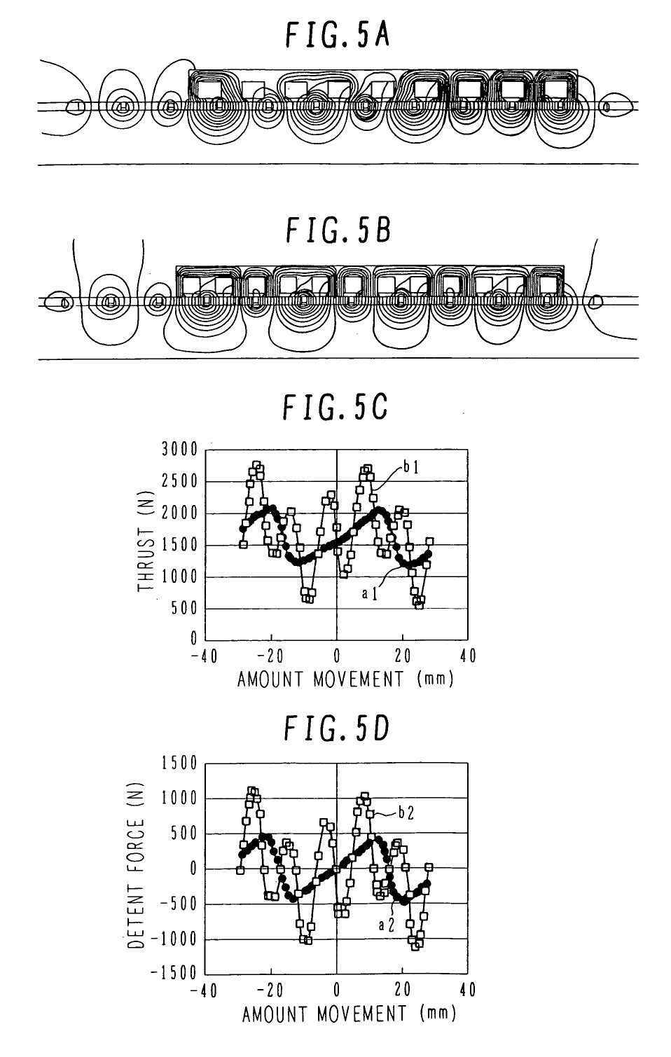

With reference to FIGS. 5A-5D, a description is made of the effect resulting when the cylindrical linear motor used in the electromagnetic suspension of the embodiment satisfies τp:τs=9:8.

FIGS. 5A-5D are illustrations and graphs for explaining the effect resulting when the cylindrical linear motor used in the electromagnetic suspension according to the embodiment satisfies τp:τs=9:8.

FIG. 5A represents a distribution of lines of magnetic force resulting from theoretical calculations when the cylindrical linear motor used in the electromagnetic suspension of the embodiment satisfies τp:τs=9:8. On the other hand, FIG. 5B represents, as a comparative example, a distribution of lines of magnetic force resulting from theoretical calculations when τp:τs=12:8 holds.

In the graph of FIG. 5C, the horizontal axis indicates the amount of movement (mm), and the vertical axis indicates the thrust (N). In the graph, a curve a1 represents torque changes resulting when the cylindrical linear motor used in the electromagnetic suspension of the embodiment satisfies τp:τs=9:8. A curve b1 represents torque changes resulting with the comparative example where τp:τs=12:8 holds. As seen from FIG. 5C, the curve b1 shows larger maximum torque, but the torque changes (pulsations) are increased. In contrast, with the cylindrical linear motor used in the electromagnetic suspension of the embodiment satisfying τp:τs=9:8, the torque changes can be reduced as represented by the curve a1.

Further, in the graph of FIG. 5D, the horizontal axis indicates the amount of movement (mm), and the vertical axis indicates the detent force (cogging torque) (N). In the graph, a curve a2 represents the cogging torque resulting when the cylindrical linear motor used in the electromagnetic suspension of the embodiment satisfies τp:τs=9:8. A curve b2 represents the cogging torque resulting with the comparative example where τp:τs=12:8 holds. As seen from the curve a2 in FIG. 5D, the cogging torque can be reduced in the case where the cylindrical linear motor used in the electromagnetic suspension of the embodiment satisfies τp:τs=9:8.

While the above description is made of the case where the cylindrical linear motor satisfies τp:τs=9:8, the case of satisfying τp:τs=9:10 can also provide a similar effect; namely, the torque changes can be reduced substantially in the same extent as represented by the curve a1 in FIG. 5C in comparison with the curve b1, and the cogging torque can also be reduced substantially in the same extent as represented by the curve a2 in FIG. 5D in comparison with the curve b2.

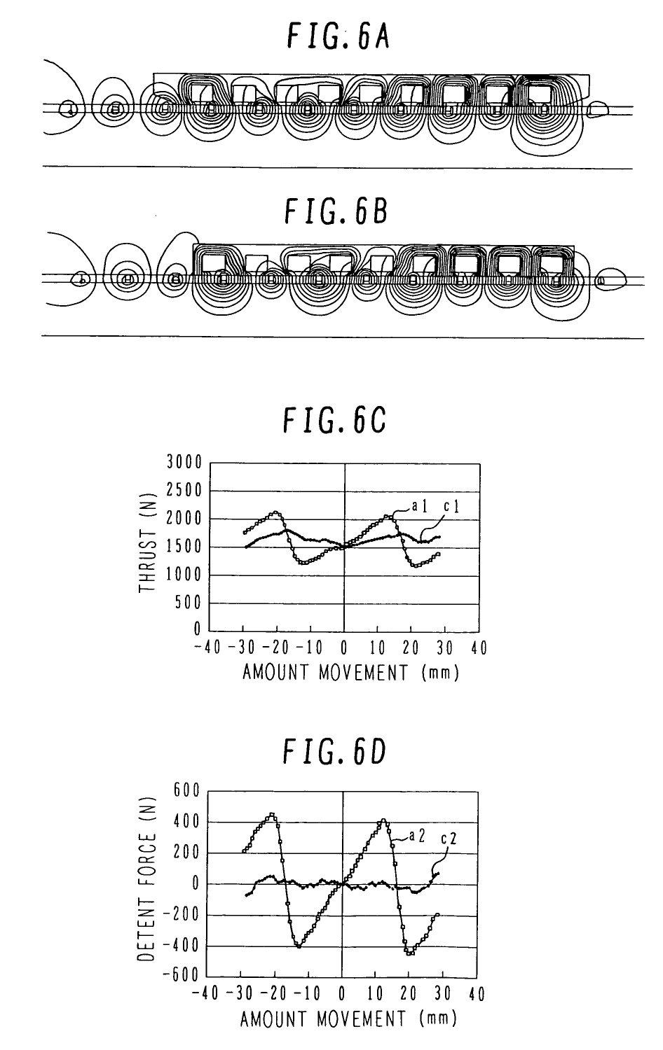

With reference to FIGS. 6A-6D, a description is made of the effect resulting when the cylindrical linear motor used in the electromagnetic suspension of the embodiment is provided with the auxiliary salient poles 114P.

FIGS. 6A-6D are illustrations and graphs for explaining the effect resulting when the cylindrical linear motor used in the electromagnetic suspension according to the embodiment is provided with the auxiliary salient poles.

FIG. 6A represents a distribution of lines of magnetic force resulting from theoretical calculations when the cylindrical linear motor used in the electromagnetic suspension of the embodiment satisfies τp:τs=9:8 and the auxiliary salient poles are disposed at both the ends of the stator. On the other hand, FIG. 6B represents a distribution of lines of magnetic force resulting from theoretical calculations when τp:τs=9:8 is satisfied, but the auxiliary salient poles are not provided as in FIG. 5A.

In the graph of FIG. 6C, the horizontal axis indicates the amount of movement (mm), and the vertical axis indicates the thrust (N). In the graph, a curve a1 represents, as in FIG. 5C, torque changes resulting when the cylindrical linear motor used in the electromagnetic suspension of the embodiment satisfies τp:τs=9:8, but the auxiliary salient poles are not provided. A curve c1 represents torque changes resulting when τp:τs=9:8 is satisfied and the auxiliary salient poles disposed at both the ends of the stator. As seen from the curve c1 in FIG. 6C, the case where the cylindrical linear motor used in the electromagnetic suspension of the embodiment satisfies τp:τs=9:8 and the auxiliary salient poles are disposed at both the ends of the stator can reduce the torque changes in comparison with the case where the auxiliary salient poles are not provided as represented by the curve a1 in FIG. 6C.

Further, in the graph of FIG. 6D, the horizontal axis indicates the amount of movement (mm), and the vertical axis indicates the detent force (cogging torque) (N). In the graph, a curve a2 represents, as in FIG. 5D, the cogging torque resulting when the cylindrical linear motor used in the electromagnetic suspension of the embodiment satisfies τp:τs=9:8, but the auxiliary salient poles are not provided. A curve c2 represents the cogging torque resulting when the cylindrical linear motor used in the electromagnetic suspension of the embodiment satisfies τp:τs=9:8 and the auxiliary salient poles are disposed at both the ends of the stator. As seen from the curve c2 in FIG. 6D, the case where the cylindrical linear motor used in the electromagnetic suspension of the embodiment satisfies τp:τs=9:8 and the auxiliary salient poles are disposed at both the ends of the stator can reduce the cogging torque in comparison with the case where the auxiliary salient poles are not provided as represented by the curve a2 in FIG. 6D.

While the above description is made of the case where the cylindrical linear motor satisfies τp:τs=9:8, the case of satisfying τp:τs=9:10 can also provide a similar effect; namely, the torque changes can be reduced substantially in the same extent as represented by the curve c1 in FIG. 6C in comparison with the curve a1, and the cogging torque can also be reduced substantially in the same extent as represented by the curve c2 in FIG. 6D in comparison with the curve a2.

Thus, with the motor satisfying τp:τs=9:9±1, it is possible to reduce not only the torque changes, but also the cogging torque.

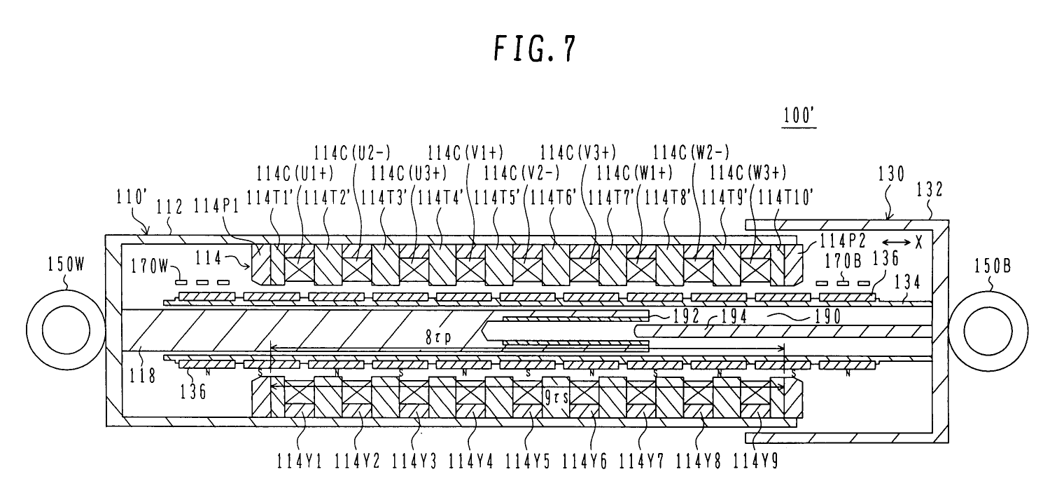

The structure of a cylindrical linear motor used in an electromagnetic suspension according to a modification of the foregoing embodiment will be described below with reference to FIG. 7.

FIG. 7 is a longitudinal sectional view showing the structure of the cylindrical linear motor used in the electromagnetic suspension according to the modification of the embodiment. Note that the same reference numerals as those in FIG. 1 denote the same components.

A permanent magnet type 3-phase cylindrical linear motor 100′ of this modification comprises a cylindrical stator 110′ and a cylindrical slider 130 held inside the stator 110′ in a slidable manner. This modification differs from the embodiment shown in FIG. 1 in the structure of ten ring-shaped stator core teeth (stator salient poles) 114T′ (114T1′, 114T2′, . . . , 114T10′) constituting the stator 110′. The structures of other components, i.e., stator core yokes 114Y, stator windings 114C, and auxiliary salient poles 114P, are the same as those in FIG. 1.

In the embodiment shown in FIG. 1, the projections projecting in the direction indicated by X are formed at the innermost peripheral ends of each of the stator core teeth 114T, whereby the width of an entrance opening of the slot is narrowed to be smaller than that of the stator winding 114C. In contrast, the stator core teeth (stator salient poles) 114T′ in this modification are not provided with the projections shown in FIG. 1, and the slot accommodating the stator winding 114C is formed as a straightly open slot. With such a modified structure, the stator can be more easily manufactured.

The configuration of the control unit for the electromagnetic suspension of the embodiment will be described below with reference to FIGS. 8-10. The following description is made of, by way of example, in connection with an electromagnetic suspension for use in motor vehicles.

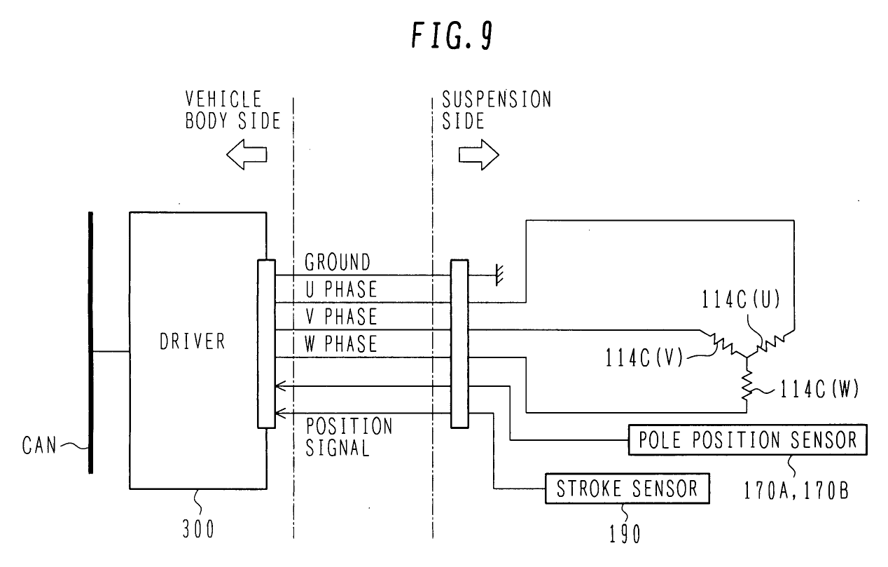

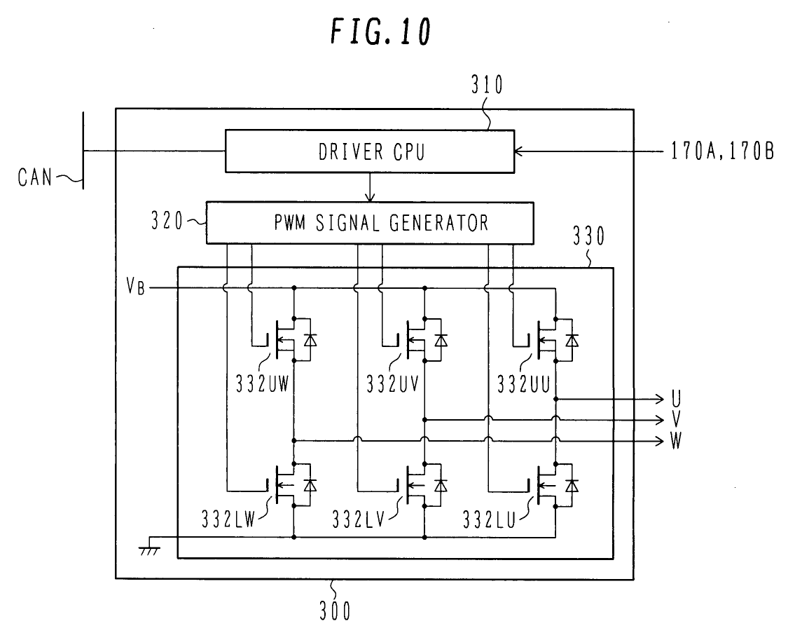

FIG. 8 is a system block diagram showing the configuration of the electromagnetic suspension according to the embodiment. FIG. 9 is a block diagram showing the configuration of a principal part of the electromagnetic suspension according to the embodiment. FIG. 10 is a block diagram showing the configuration of a driver circuit used in the electromagnetic suspension according to the embodiment. Note that the same reference numerals as those in FIG. 1 denote the same components.

As shown in FIG. 8, the electromagnetic suspension comprises suspension units 100FL, 100FR, 100RL and 100RR each including the above-described cylindrical linear motor, and drivers 300 (300FL, 300FR, 300RL and 300RR) for driving the corresponding cylindrical linear motors. The cylindrical linear motor in each of the suspension units 100FL, 100FR, 100RL and 100RR has the same structure as that shown in FIG. 1.

The suspension unit 100FL is interposed between a member on the front left wheel side and a vehicle body, and the suspension unit 100FR is interposed between a member on the front right wheel side and the vehicle body. The suspension unit 100RL is interposed between a member on the rear left wheel side and the vehicle body, and the suspension unit 100RR is interposed between a member on the rear right wheel side and the vehicle body.

The drivers 300FL, 300FR, 300RL and 300RR are disposed in suspension towers corresponding to the respective wheels. A high-voltage power supply (battery) BH of DC 36 V is connected to the drivers 300 (300FL, 300FR, 300RL and 300RR).

The drivers 300 are connected to a suspension control unit (SCU) 200 via a CAN bus. For the purposes of suppressing vibrations of the vehicle and controlling the vehicle posture, the SCU 200 outputs drive commands to the drivers 300 to control not only thrusts generated by the cylindrical linear motors in the suspension units 100FL, 100FR, 100RL and 100RR, but also a damping force of the vehicle body with electromotive forces of the cylindrical linear motors.

Further, connected to the SCU 200 are first, second and third normal acceleration sensors 210A, 210B and 210C for detecting normal (vertical) vibrations of the vehicle body, a wheel speed sensor 220 for detecting the wheel speed, a steering angle sensor 230 for detecting the rotational angle of a steering wheel, and a brake sensor 240 for detecting whether a brake is depressed or not. The first normal acceleration sensor 210A is disposed in the suspension tower for a front right wheel, and the second normal acceleration sensor 210B is disposed in the suspension tower for a front left wheel. The third normal acceleration sensor 210C is disposed in a trunk in a rear portion of the vehicle body.

Based on respective signals from the first, second and third normal acceleration sensors 210A, 210B and 210C, the wheel speed sensor 220, the steering angle sensor 230, and the brake sensor 240, as well as from a signal from the stroke sensor 190 described above with reference to FIG. 1, the SCU 200 decides values of control variables for the suspension units 100FL, 100FR, 100RL and 100RR so that vibrations of the vehicle, changes of the vehicle posture, and unstable behaviors of the vehicle are suppressed and the vehicle is further stabilized with respect to the vehicle speed and the steering and braking operations applied from a driver operating the vehicle. Then, the SCU 200 outputs signals for driving the cylindrical linear motors to the drivers 300.

The configuration of each of the drivers 300 will be described below with reference to FIGS. 9 and 10.

As shown in FIG. 9, the U-phase coil (stator windings) 114C(U), the V-phase coil (stator windings) 114C(V), and the W-phase coil (stator windings) 114C(W) of the cylindrical linear motor are connected to each other in the Y-form. The driver 300 supplies drive currents of the U-, V- and W-phase to the corresponding coils of the respective phases. Pole position signals detected by the pole position sensors 170A, 170B are inputted to the driver 300. A stroke amount signal detected by the stroke sensor 190 is inputted to the SCU 200 from the driver 300 via the CAN bus (CAN).

As shown in FIG. 10, the driver 300 comprises a driver CPU 310, a PWM signal generator 320, and a semiconductor switching device 330. The semiconductor switching device 330 is made up of a U-phase upper arm MOS-FET 332UU, a U-phase lower arm MOS-FET 332LU, a V-phase upper arm MOS-FET 332UV, a V-phase lower arm MOS-FET 332LV, a W-phase upper arm MOS-FET 332UW, and a W-phase lower arm MOS-FET 332LW. In accordance with the suspension drive commands supplied from the SCU 200 via the CAN bus (CAN), the driver CPU 310 outputs control signals for PWM driving of the semiconductor switching device 330. Also, in accordance with the control signals supplied from the driver CPU 310, the PWM signal generator 320 outputs on/off drive signals to respective gates of the MOS-FETs constituting the semiconductor switching device 330.

According to the present invention, as described above, the thrust can be increased and the torque pulsations and the cogging torque can be reduced by setting the pitch τs of the stator salient poles and the pitch τp of the permanent magnets so that τp:τs=9:8 or 9:10 is satisfied.

What is claimed is:

1. A cylindrical linear motor comprising a stator and a slider disposed with a gap left relative to said stator and being linearly movable relative to said stator,
said stator comprising:
a stator core having stator salient poles; and
3-phase stator windings inserted in slots formed in said stator core,
said slider comprising a plurality of permanent magnets fixed to a slider core, and
said motor satisfying τp:τs=9:9±1 where τs is a pitch of said stator salient poles and τp is a pitch of said permanent magnets.

2. The cylindrical linear motor according to claim 1, further comprising auxiliary salient poles disposed at outermost ends of said stator core on both sides.

3. The cylindrical linear motor according to claim 1, wherein said stator windings are continuously wound per phase.

4. The cylindrical linear motor according to claim 1, wherein said stator core has projections formed on a surface thereof on the side opposite to said slider and projecting in a direction of movement of said slider to come into an entrance opening of the corresponding slot.

5. The cylindrical linear motor according to claim 1, wherein said stator core comprises a plurality of stator yokes and a plurality of stator salient poles which are alternately arranged.

6. The cylindrical linear motor according to claim 1, wherein said stator salient pole is formed of a green compact.

7. A cylindrical linear motor comprising a stator and a slider disposed with a gap left relative to said stator and being linearly movable relative to said stator,
said stator comprising:
a plurality of stator yokes and a plurality of stator salient poles which are alternately arranged on the inner peripheral side of a cylindrical stator case; and
3-phase stator windings inserted in slots each of which is formed by one of said stator yokes and two of said stator salient poles,
said slider comprising a plurality of permanent magnets arranged at intervals therebetween on an outer periphery of a slider core, and
said motor satisfying τp:τs=9:8 or 9:10 where τs is a pitch of said stator salient poles and τp is a pitch of said permanent magnets.

8. The cylindrical linear motor according to claim 7, further comprising auxiliary salient poles disposed outward of two of said stator salient poles which are positioned at both ends thereof.

9. The cylindrical linear motor according to claim 8, wherein a surface of each of said auxiliary salient poles opposite to said slider is formed at an angle θ1 (θ1<90°) relative to a radial direction of said stator.

10. A cylindrical linear motor comprising a stator and a slider disposed with a gap left relative to said stator and being linearly movable relative to said stator,
said stator comprising:
a plurality of ring-shaped stator yokes and a plurality of ring-shaped stator salient poles which are alternately arranged on the inner peripheral side of a cylindrical stator case; and
3-phase ring-shaped stator windings inserted in slots each of which is formed by one of said stator yokes and two of said stator salient poles,
said slider comprising a plurality of ring-shaped permanent magnets arranged at intervals therebetween on an outer periphery of a cylindrical slider core, and
said motor satisfying 8 τp=9 τs or 10 τp=9 τs where τs is a pitch of said stator salient poles and τp is a pitch of said permanent magnets.

11. The cylindrical linear motor according to claim 10, further comprising auxiliary salient poles disposed outward of two of said stator salient poles which are positioned at both ends thereof, to smooth torque generated by said cylindrical linear motor.

12. An electromagnetic suspension comprising:
a cylindrical linear motor comprising a stator including stator windings, and a slider disposed with a gap left relative to said stator and being linearly movable relative to said stator; and
a control device for controlling currents supplied to said stator windings of said cylindrical linear motor,
said stator comprising:
a stator core having stator salient poles; and
3-phase stator windings inserted in slots formed in said stator core,
said slider comprising a plurality of permanent magnets fixed to a slider core, and
said motor satisfying τp:τs=9:9±1 where τs is a pitch of said stator salient poles and τp is a pitch of said permanent magnets.

13. A vehicle comprising:
an electromagnetic suspension unit mounted between a vehicle body and a wheel and including a cylindrical linear motor which comprises a stator including stator windings, and a slider disposed with a gap left relative to said stator and being linearly movable relative to said stator;
a control device for controlling currents supplied to said stator windings of said cylindrical linear motor in said electromagnetic suspension unit; and
a motion detecting device for detecting a motion of said vehicle body,
said stator of said cylindrical linear motor comprising:
a stator core having stator salient poles; and
3-phase stator windings inserted in slots formed in said stator core,
said slider comprising a plurality of permanent magnets fixed to a slider core,
said motor satisfying τp:τs=9:9±1 where τs is a pitch of said stator salient poles and τp is a pitch of said permanent magnets, and
said control device controlling the currents supplied to said stator windings of said cylindrical linear motor in such a manner that the vehicle motion detected by said motion detecting device are suppressed.
